(19) United States
(12) Patent Application Publication
(10) Pub. No.: US 2009/0005161 A1
(43) Pub. Date: Jan. 1, 2009

(54) Prize allocation and notification regarding electronic games ranking

(75) Inventor: Paul Aouizerate, Tel-Aviv (IL)

Correspondence Address: FRISHAUF, HOLTZ, GOODMAN & CHICK, PC, 220 Fifth Avenue, 16TH Floor, NEW YORK, NY, 10001-7708, US

(73) Assignee: CHARLES & PAUL LTD., Tel-Aviv (IL)

(21) Appl. No.: 12/156,336

(22) Filed: May 30, 2008

(30) Foreign Application Priority Data
Jun. 26, 2007 (IL) 184224

(51) Int. Cl. A63F 9/24

(52) U.S. Cl. 463/25

(57) ABSTRACT

Method and system for determining recipients of prizes based on their performance in electronic games and notifying the recipients of their prizes includes ranking subjects involved in electronic games using a processor, deriving a prize allocation distribution for the subjects based on the ranking and notifying the subjects that have been allocated prizes of their prizes. The subjects may be a plurality of players, a plurality of teams each including a plurality of players, a plurality of games each involving a plurality of players, or a plurality of tournaments each involving a plurality of teams playing a plurality of games.

### FIELD OF THE INVENTION

The present invention relates generally to a method, a system and application programs for ranking subjects associated with electronic games, or e-games ranking, and more particularly for ranking subjects including players, teams each including a plurality of players, games and tournaments each including a plurality of games.

The present invention also relates generally to a method, system and application programs for using a ranking of subjects associated with electronic games in order to allocate prizes, and notifying the recipients of the prizes.

### BACKGROUND OF THE INVENTION

Every month, electronic game engines monitor more than 80 million playing hours on tens of thousands of different game servers all over the world. Electronic games are considered in the broad aspect of the word, i.e., not only as an amusement for passing time, but also as a mental competition or a contest of skills. For example, the game of chess has also an electronic game version. Some electronic games may be considered as a virtual sport, and called e-Sport or e-Gaming worldwide.

The winners of different electronic gaming competitions and contests receive prizes currently totaling more than about $1,500,000. More than two million visitors communicate daily with websites, servers and databases related to electronic games, for which about some 250 millions pages per month are displayed. There is thus a huge worldwide market and interest in electronic games.

However, at the present time, there is not believed to any worldwide ranking for participants in electronic games and moreover, there are not believed to be any rules for ranking participants in electronic game tournaments, for leagues including a plurality of teams of players playing electronic games, for specific electronic games, for the teams of players, and for the players. As used herein, the term “tournament” refers to competitions, matches, events and play-offs involving a plurality of teams playing a plurality of games, and even to the equivalent of Olympic games. Also, the term “ranking” means the attribution of points, absolute or normalized, as necessary for listing subjects involved in playing electronic games by order of the number of points.

It would therefore be desirable to establish a worldwide standard for the ranking of participants or subjects involved in playing electronic games in order to obtain a ranking list. For example, it would be advantageous to rank e-Sport scene games using a method for ranking electronic sport teams on a calendar-basis, according to local, national, and international competitions, based on rules and criteria.

Such a ranking list would help the highly ranked subjects, and especially those ranked at the top of the list, to obtain support, to gain recognition, to reap prizes, and/or to become financially and economically successful. A worldwide ranking, possibly in various classes, leagues, games, and zones, could thus provide a useful, valuable, concrete and tangible asset for subjects that are ranked methodically according to well-established rules.

Many entities are willing to provide sponsorship and support to 5 electronic gaming and contests of various kinds, and thus would clearly benefit from knowledge of a ranking of participants in such electronic games and contest. For example, often a governmental entity may want to reward participants in educational or cultural electronic gaming events, an academic facility may want to offer financial inducements for participants in science competitions, and industrial entities may want to encourage electronic contests related to social purposes or to their own interests.

It is therefore a significant problem that there is no currently known mechanism for ranking subjects or participants in electronic gaming on a worldwide, regional, or even local level and the providing for an equitable allocation of prizes and notification of rewards based on the ranking.

### OBJECTS AND SUMMARY OF THE INVENTION

It is an object of the present invention to provide a method, a system and application programs for ranking subjects associated with electronic games, or e-games ranking, the subjects including players, teams each including a plurality of players, games and tournaments each including a plurality of games.

It is another object of the present invention to provide a method, system and application programs for using a ranking of subjects associated with electronic games in order to allocate prizes, and notifying the recipients of the prizes.

In order to achieve one or both of these objects, a method for determining recipients of prizes based on their performance in electronic games and notifying the recipients of their prizes in accordance with the invention includes ranking subjects involved in electronic games using a processor, deriving a prize allocation distribution for the subjects based on the ranking and notifying the subjects that have been allocated prizes of their prizes. The subjects may be a plurality of players, a plurality of teams each including a plurality of players, a plurality of games each involving a plurality of players, or a plurality of tournaments each involving a plurality of teams playing a plurality of games. A related system would include means for performing these functions, e.g., a processor, an optional memory component for storing data about the subjects and information about the games, and a prize and notification delivery unit which notifies the subjects of their prizes and if accepted, arranges for delivery of the prizes to the subjects.

An operator is provided with the ability to control the prize allocation derivation, e.g., by determining parameters thereof, and/or determine the manner in which the subjects are notified of their allocated prizes.

Ranking the subjects may entail receiving data about the subjects and applying a ranking calculation algorithm to the data which may include a plurality of rules. The operator can determine the rules for the ranking calculation algorithm to apply to the data in order to derive the ranking. The rules may be selected from a first set of rules for ranking players, a second set of rules for ranking teams, a third set of rules for ranking games and a fourth set of rules for ranking tournaments.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic drawing showing the major components of a system for ranking subjects involved in electronic games in accordance with the invention

FIG. 2 shows a list of steps for ranking subjects involved in an electronic game in accordance with the invention.

FIG. 3 shows an operation of a computer program for ranking subjects in accordance with the invention.

FIG. 4 is a schematic drawing showing the major components of a system for awarding prizes to subjects involved in electronic games and notifying the subjects that will be receiving prizes in accordance with the invention.

FIG. 5 is a representation of the prizing awarding and delivery notification system shown in FIG. 4.

FIG. 6 is a conceptual block diagram of the system shown in FIG. 4.

FIG. 7 shows an operation of a computer program for allocating prizes and notifying winners of the prizes about the delivery thereof in accordance with the invention.

### DETAILED DESCRIPTION OF THE INVENTION

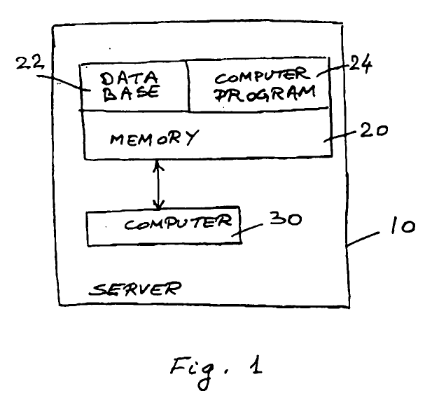

The invention generally relates to techniques for determining subjects involved in playing electronic games of prizes they have won and notifying the subjects of their prizes in which the prizes are allocated based on a ranking. Several techniques for ranking the subjects are disclosed below with reference to FIGS. 1-3, but it should be understood that these disclosed techniques do not limit the application of the invention and thus, any technique for ranking subjects involved in playing electronic games may be used in the invention.

Referring then first to FIGS. 1-3 which relate to exemplifying techniques for ranking subjects of electronic games, FIG. 1 is a schematic drawing showing the major components of a system for ranking subjects involved in electronic games in accordance with the invention. The system includes a server 10 having a memory 20, which is a computer-readable medium, for storing data in a database 22 thereof and for storing one or more computer programs 24. Each computer program 24 is a computer-readable medium encoded with a set of instructions capable of being executed by a computer 30 to which it is coupled. The memory 20 is coupled in bi-directional communication to the computer 30 or other computational device including a processor. Instead of a server 10, other configurations of a processing platform may be provided, i.e., any arrangement of electronic components which provide a memory and is capable of executing computer programs.

The server 10 may be coupled to the Internet, or its functions may be implemented at a Website. Instead of a single server 10, a plurality of servers 10 may be provided. Also, the memory 20 may distributed over a plurality of geographically separated sites on the Internet.

A ranking process in accordance with the invention using the server 10, including the database 22 and the computer program 24, may be directed and controlled by a program administrator having access to the computer 30. The program administrator is empowered to make decisions relating to the manner in which the ranking process is performed by the server 10, including decisions to modify the operation of any of the elements of the server 10. For example, the program administrator may decide which of a number and type of rules or criteria are to be applied in the ranking process of a subject such as a tournament, a game, a team, and a player. The rules and criteria may be predetermined by the computer program and the program administrator provided with the opportunity to create their own rules and criteria.

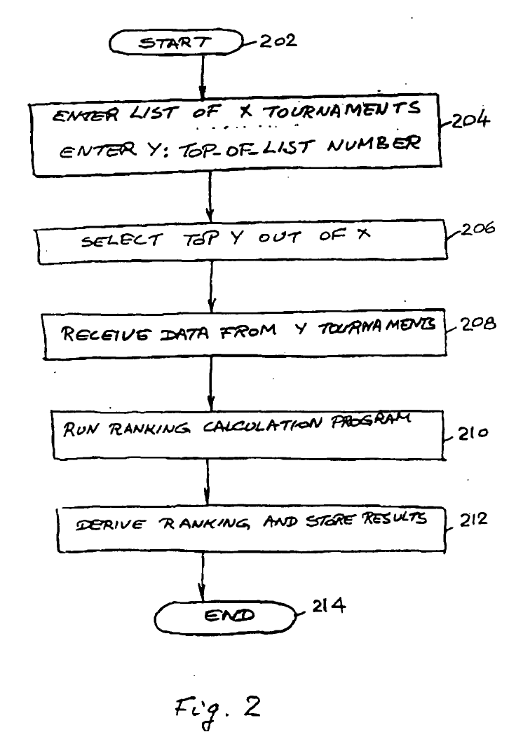

FIG. 2 shows an example of a list of steps for ranking one or more subjects involved in an electronic game which may be implemented by the server 10 shown in FIG. 1. As noted above, the subjects capable of being ranked by a method and system in accordance with the invention include a plurality of players, a plurality of teams each including one or more players, a plurality of games and a plurality of tournaments each including a plurality of games. It is assumed that data about the players, teams, games and/or tournaments, e.g., results and scores of the games and the actions of the players, are accessible to the server 10 and made available over the Internet or by other means accessible to the server 10.

A ranking may be calculated by the server 10 and a list created and disseminated periodically, e.g., monthly, but other shorter periods, as short as single days or weeks, or longer periods may be selected as desired. The list may be distributed to the players and/or teams or others over the Internet or another communications network.

The ranking calculation procedure starts at step 202. In step 204, an integer number x, representing a list of selected subjects, e.g., electronic game tournaments, is entered into the memory 20 of the server 10, together with an integer number y smaller than x. The program administrator may perform this data input, or it may be automatic. In step 206, the computer program 30 selects a number of y tournaments from the list of x tournaments, e.g., the highest y tournaments on the list. Then, in step 208, the computer program 24 accesses the selected tournaments via the Internet, to receive data about the subjects. The tournament data is stored in memory 20 as input data for the computer program 24.

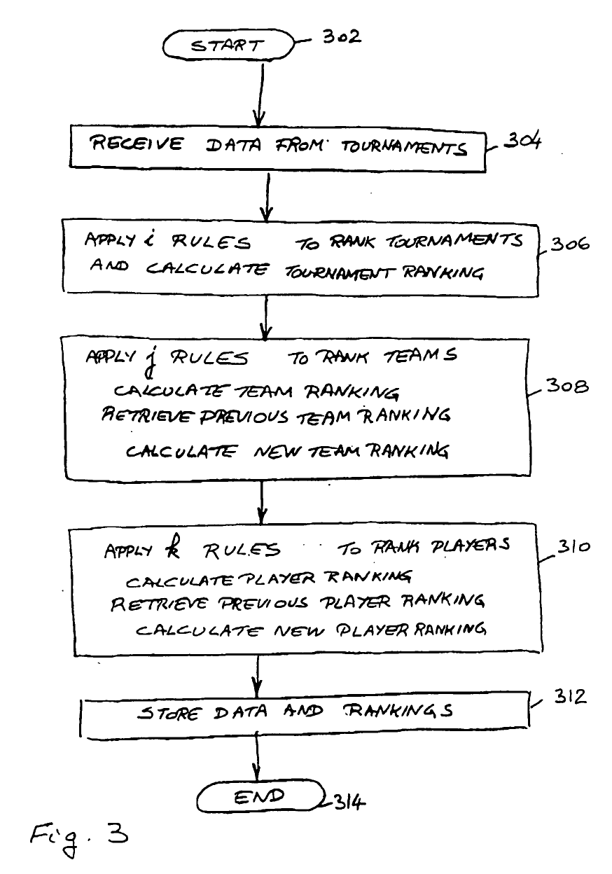

In step 210, the computer program 24 is operated to run a ranking calculation procedure on the received tournament data (described with reference to FIG. 3 below). The ranking calculation procedure operates on a portion of or all the subjects as determined by, for example, the program administrator.

In step 212, the requested ranking is calculated or derived and stored in the database 22, for immediate or subsequent distribution. 5 The ranking calculation procedure ends at step 214.

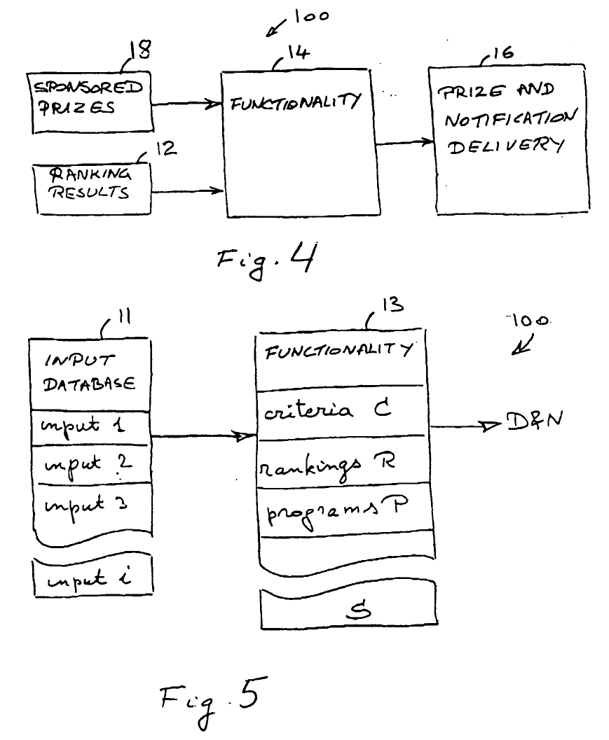

The list of steps operated for ranking one or more subjects as illustrated in FIG. 2 is repeated for each specific type of electronic game for which a ranking is sought, possibly for the purpose of awarding prizes to the best subjects in the manner described below with reference to FIGS. 4-7. Each specific game may be regarded as a specific sport, e.g., basketball, football, soccer, volleyball, and so on.

The results of the ranking calculation procedure are likely to be considered proprietary to the operator of the server 10, or the manager of the ranking system, and are distributed, displayed and/or allowed for use at the discretion of the operator or manager, possibly only for use by authorized parties having restricted access to the server 10. Such parties are possibly licensees, organizers of tournaments, producers of electronic games, owners of teams, players, and the like.

FIG. 3 is an example of the operation of a computer program 24 by computer 30 to perform the ranking calculation procedure in order to derive a ranking result of the subjects, according to a set of predetermined rules.

In FIG. 3, an exemplary ranking calculation procedure for specific tournaments starts at step 302. In step 304, data from the tournaments is collected and received (corresponding to step 208 in FIG. 2). The ranking of tournaments is calculated in step 306, according to a number of “i” rules or criteria, with i=1, 2, 3, . . . , n (corresponding to step 210 in FIG. 2). For example, one rule may relate to the number of teams participating in one of the selected number of tournaments. Thus, the higher the number of participating teams, the higher the rank. Another rule may relate to only those teams previously selected by the operator of the server 10. Different rules may apply to the selection of the number of teams to be ranked.

In step 308, a number “j” rules or criteria are applied for the ranking of teams each including a plurality of players, with j=1, 2, 3, . . . , n. For example, teams may be ranked according to score results, or ranked according to the shortest time needed for winning a game, and so on. Once the teams are ranked, a recalculation of the ranking may proceed if desired, according to the last previous ranking which would be retrieved from memory 22. For example, a team may receive a bonus for continuous success or improvement of scored performance, or a reduction for deteriorating achievements.

In step 310, a number “k” rules are applied for the ranking of players, with k=1, 2, 3, . . . , n. For example, players may be ranked according to individual score results, or ranked according to the shortest time needed for each of them to score a predetermined number of points in a game. Once players are ranked, a recalculation of the ranking may proceed if desired, according to the last previous ranking which would be retrieved from memory 22. For example, a player may receive a bonus for continuous success or improvement of scored performance, or a reduction for deteriorating achievements.

It is noted that even though steps 306, 308, and 310 are listed in a sequence, some steps may be skipped. For example, it might be desired to only rank tournaments. Alternatively, it may be desired to rank either teams or players and, for example, use the same rules for ranking a team and for ranking a player. Various selections and combinations of the subjects to be ranked and of the rules to be applied are thus possible.

Further, it is also possible to apply a number of rules to rank games instead of or in addition to the application of rules to rank players, teams and tournaments.

In step 312, the data and rankings are stored. Data received from the tournaments in step 304 may or may not affect the ranking depending on the rules applied. For example, data may include the age and the height, or weight, education, status, or any other personal information about a player. Similar data may be collected for teams, such as average age, average years of education, and the like. Data may thus include any information associated with a subject to be ranked. However, some rules being applied may not require consideration of the data while other rules would entail consideration of such data.

In step 314, the ranking calculation procedure ends.

Other techniques for ranking subjects may be implemented, but the rules must always be consistent and calculated in the same manner to allow a valued and recognized worldwide comparison. For further example, ranking may be achieved in two phases. In a first phase, a list of tournaments is first selected, e.g., a number “p” tournaments. Then a list of a number “q” games is selected from the tournaments. Finally, points of ranking are given to certain games out of the tournaments. Rules for ranking are predetermined and selected as desired. In a second phase, the selection of a subject “r” is first undertaken, which is either list of a number “rT” teams or a list of a number “rP” players. Then, the subject r, either rT or rP is ranked, by receiving points according to predetermined rules. In turn, a list of a number “s” tournaments is selected, and from those, a number “t” games are selected. Next, the subject “r” is selected, according to ranking, out of the number “s” tournaments and the number “t” games. In addition to the obtained ranking, the ranking of the top “r” subjects is recalculated and an updated ranking of the subjects is obtained. Variations to the ranking calculation procedure and rules of calculation are applied as desired but must be consistently applied.

As described above, the calculated ranking may be displayed and distributed to users with the permission of the operator of the server 10 on which the ranking calculation procedure is being performed.

The ranking method described above is applicable in the computer, communication, and information industry, and is in general implemented in hardware and/or in software computer programs running on a suitable platform.

Once the subject has been ranked, the present invention also encompasses the ability to award prizes to the subjects based on the ranking, and notify the subjects who have been awarded prizes.

To this end, FIG. 4 illustrates the main components of a system for awarding prizes to subjects involved in electronic games and notifying the subjects that will be receiving prizes, the system being designated generally as 100. Prizes 18, which may be prizes received from sponsors for allocation to winning subjects related to electronic games or otherwise, are identified. Ranking results 12 of the electronic games are provided (for example, as described above with respect to FIGS. 1-3). Both the prizes 18 and the ranking results 12 are directed into a functionality module or processor 14, which operates one or more allocation mechanisms for distributing prizes according to predefined rules. An operator is involved in the process and may provide commands or instructions to the processor 14 to thereby enable the operator to control the prize allocation procedure, as well as the prize delivery notification procedure.

Output from the processor 14 includes the prize allocation results, according to which prizes may be delivered to winning subjects with or without an accompanying notification. To this end, a prize and notification delivery element 16 is provided.

A prize 18 may be an award or a reward, which may be material such as a monetary retribution, an equivalent to money, or an immaterial honor such as a token of recognition, and may thus span a wide spectrum of possible types of prizes ranging from monetary prizes, to personal satisfaction items. Prizes may be offered by official and private sponsoring organizations, by organized groups, and by individuals. However, not all prize offers have to be accepted automatically. Prizes may be declined, for example when originating from an unwanted or inappropriate source. Therefore, acceptance criteria may be applied prior to accepting a prize for allocation. That is, the subject may be notified that they will be receiving a prize and the sponsor of that prize and may be provided with an opportunity to decline to accept the prize.

Ranking results of subjects related to electronic games may be obtained as desired, either in real time or intermittently, and delivered by a ranking calculation procedure described above with reference to FIGS. 1-3, e.g., by server 10. It is important to appreciate that the reward determination by processor 14 may be based on a ranking calculation obtained by a procedure other than that described above with reference to FIGS. 1-3.

However, even though ranking results are or may be made available, not all proposals have to be used to determine the allocation of prizes. For example, gaming subjects related to violence, cruelty, immorality, or other unwanted subjects may be rejected and thus declared ineligible to be allocated prizes.

The prize allocation functionality or processor 14 may include appropriate computation and communication hardware and appropriate software or computation application programs for processing the ranking results and to determine a prize allocation distribution. The application programs may operate any logic mechanism for the distribution of prizes, according to any empirical, heuristic, mathematical function, or a combination thereof. For example, prize allocation computer programs may operate any linear, exponential, or other user-selected prize-allocation distribution that is mathematically monotonic progressive or having discontinuities and/or singularities.

The output results of the processor 14 may be forwarded to the prize and delivery notification element 16 which may take the form of a facility. The facility would handle the transfer of the prizes to the winners, i.e., the selected recipients. Depending on their form, prizes may be transferred by wire or delivered physically. In addition, notification to the winners and the prizes they received may be provided to the public at large and/or media via a plurality of media channels. Notification to the media is a sign of recognition, of reputation, of goodwill, as well as publicity. The media may be notified using conventional media channels such as radio, television, and the printed press, and/or using the Internet, with delivery to specific selected URL's, e-mail addresses and sites, as well as to cellular phones. The notification may appear for example as a banner on the site of a winner, on the Internet in general, only on a specific list of announcement recipients, and/or on the display of a cellular phone. However, the manner in which the prize recipients are notified may be determined by the operator, and include delivery only to specific recipients or subjects associated with electronic gaming, delivery which is restricted only to a specific, selected list of addresses such as for example URL's, email addresses, Internet sites, and cellular phones.

Sponsored prizes and ranking results are just an example of input data provided to the processor 14. Conditions set by the sponsors, by the operator of the system for awarding prizes, and further items may also be regarded as input data. Therefore, the input data may be considered as a set A having a plurality of elements.

In addition, before being fed into the processor 14, the input data may be filtered according to, for example, acceptance criteria. This means that the first main set A of input data may be accepted as a whole, in part or not at all, according to predetermined acceptance criteria. The acceptance criteria may be considered as a second main set B also having a plurality of elements.

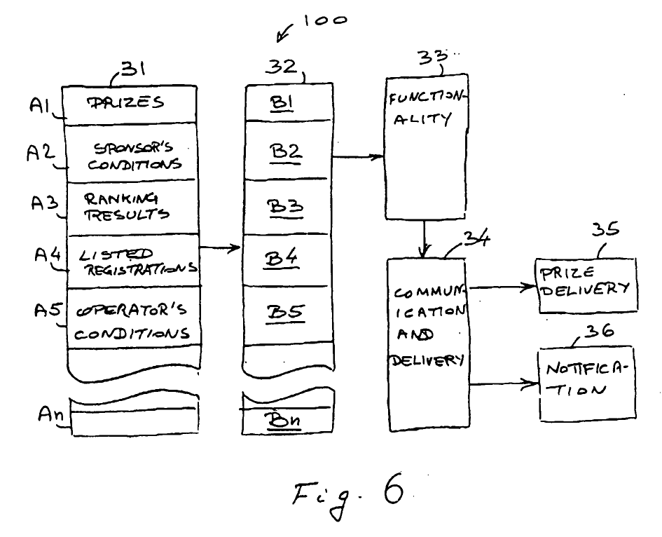

FIG. 5 is a representation of the prizing awarding and delivery notification system 100 of FIG. 4. An input database 11 may contain the necessary input data, marked as input data ranging from 1 to I (input 1, input 2, . . . , input i), for operation of the prizing awarding and delivery notification system 100. A functionality or processor 13 may be operative to run acceptance criteria C, to receive or to compute electronic game rankings R (as described above with respect to FIGS. 1-3), to operate prize distribution computer programs P and for output of equitable prize allocation distributions and notifications, designated D&N. In addition, the processor 13 may provide further services designated S.

Even though shown as being contained into two single blocks 11 and 13, the prizing awarding and delivery notification system 100 is not necessarily a local facility but may be centralized or decentralized over many locations in wired or wireless communication with each other, and/or over one or more communications networks, including the Internet.

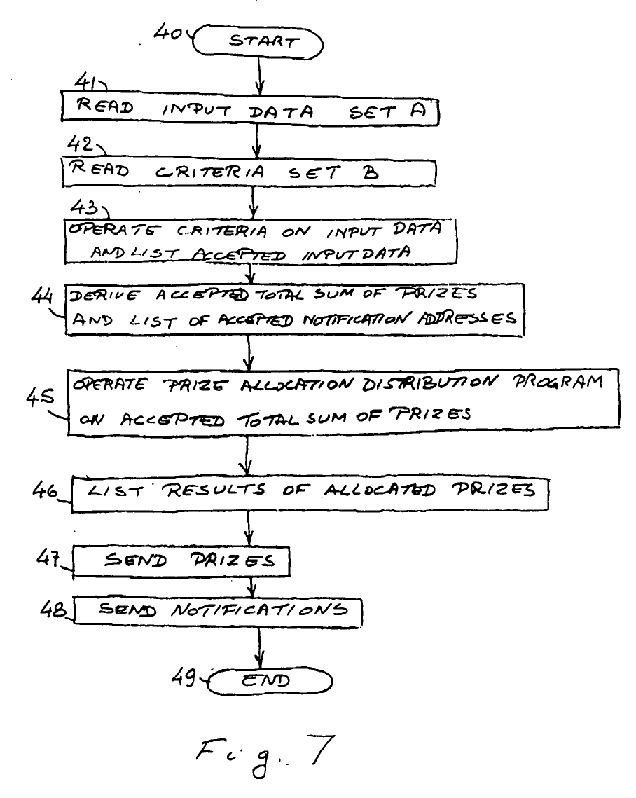

FIG. 6 is a conceptual block diagram providing a more detailed representation of FIG. 4. FIG. 6 shows a first block 31 containing a first main set A of input data, which contain elements I, thus A=I(1, 2, 3, . . . , nI), where nI is a finite integer. Each element I is also a set containing members i, thus I=i(1, 2, 3, . . . , ni), where ni is a finite integer. For example, the main set A may include an element A1, storing prizes donated by sponsors. The element A1 may have a subset, e.g., designated I1, containing a set of prizes. In this example, with reference to donated prizes, the set AI thus contains at least one sponsor A1 donating at least one prize I1. The main set A may comprise a plurality of cascading subsets in addition to the subset I.

The set A may also contain conditions, for example, conditions imposed by a sponsor of the prizes. An element A2 may be a subset of conditions, having a further subset I2 which is a string of specific conditions related to each prize, such as for example, a prize for youngsters, a prize for elderly people, a prize for citizens of one town, which may, for example, be indicated respectively as I21, I22, and I23, or I2i in general.

Furthermore, the ranking results may also be an element of the main set A, for example A3, having another subset I3, further divided into subsets I3i according to various e-game subjects.

Still another element A4 out of the main set A may represent listed registration of participants. Such participants register with the operator to become candidates for the allocated prizes should they become winners. It is the operator's decision as to whether only registered subjects may receive a prize should they win, or all subjects even those that have not registered to win prizes. The element A4 may thus have a subset of I4 listed subjects, which subset I4 is further divided into another subset I4i, for example, clubs, individuals, employees of an institution, and so on.

As a last example, an element A5 may relate to conditions imposed by the operator. A subset I5 is possibly a string of conditions having more sub-conditions related to as a subset I5i.

In conclusion, the first main set A may thus contain strings of successive subsets marked from A1 to An, each relating to a specific issue.

The input data of set A may be filtered before being fed to the functionality or processor 33 in FIG. 6. A block shown as 32 in FIG. 6 may be a second main set B for storing data acceptance criteria related to some or all of the input data of set A, and have a number “J” elements, thus B=J(1, 2, 3, . . . , nJ), where nJ is a finite integer. Each element J is also a set containing members j, with J=j(0, 1, 2, 3, . . . , nj), where J is an empty set when j=0, or where nj is a finite integer.

The sponsored prize acceptance criteria may include filters in the form of a logic condition or a computer application program. For example, the set B may include an element B1 containing acceptance criteria related to sponsors and to sponsored prizes. When j is 0, not a single prize acceptance criteria is imposed at all, meaning that the entire prize offers are admitted for acceptance. Otherwise, one criteria j, for example j1, may be applied regarding a certain type of prize(s) that may have to be rejected. For example, prizes offered by one or more group of extremists operating in disregard of norms accepted by the society may be eliminated from consideration, such as in the case of terrorists. Furthermore, a second member j2 may relate to further acceptance criteria also with respect to prize sponsors, for example regarding organizations having dubious legitimacy, or dealing with money laundering. Yet another member of the filtering criteria such as j3 for example may handle the percentage of prizes out of the totality of sponsored prizes offered by one single sponsor, to prevent a single sponsor from offering most or all of the prizes. The operator thus remains in control of the determination of the acceptance criteria to be applied, and is free to add or retrieve criteria from the set B or to any other subset.

With reference to the input data set A, such as the subset A1 for example, the operator may select acceptance criteria or filters referred to for example as B1, operative on the kind of sponsors, and on the sponsored prizes. In addition, the criteria contained in the set B1 may be subdivided into other subsets J1, J2, and so on. Furthermore, each subset Jj may relate to other sub-criteria.

In the same manner as for element A2, acceptance criteria B2 may be operated on the input conditions requested by the sponsors.

A succession of criteria may also be applied to the ranking results, similar to the criteria applied on the sponsors, the sponsored prizes, and on the sponsor's conditions. For example, a set of acceptance criteria B3 may be applied to the set of input data A3 to decide what ranking results to reject, if any. There is thus a ranking acceptance logic in the form of conditions or software computer programs that may include no ranking acceptance criteria at all, a single acceptance criteria, or a plurality of ranking acceptance criteria. These criteria are selected as desired by the operator, as described above, for example, in consideration of ranking results pertaining to e-games contrary to public norms and/or morality.

In general terms, the ranking acceptance criteria may include a main set B having J elements, where each element J is a further set of j criteria. Each acceptance criteria is possibly implemented as a logic condition or as a ranking acceptance application program operable on the processor 33, under control of the operator. For example, a selected criteria j1 may regard the ranking of a certain type of e-games, and more criteria, such as j2, j3, etc., may designate additional types of e-games for which the ranking is accepted. The operator may thus specify the types of ranking of e-games for which prizes will be allocated.

Another kind of ranking acceptance criteria j may refer to a subjective rule related to a degree of tolerance of a level of violence, cruelty, disrespect of public morality, etc. It is entirely the operator's discretion to specify which ranking acceptance criteria are to be applied for a specific run of the prize allocation distribution.

The operator may require that an e-game subject, in order to receive prizes, may have to register in a record of listed registrations. In the same manner as described above with reference to the acceptance criteria B1, B2, and B3, one may use a set of acceptance criteria B4 for example, for filtering the received input of listed registrations, since the operator is under no obligation to accept all the registered applicants. The acceptance criteria B4 may be a set of j sub-criteria applicable to various aspects regarding the listed registrations.

In the same manner, one may consider the application of acceptance criteria as a set of conditions to be imposed even on the conditions set by the operator, such as B5 for example. B5 may also have subsets, similar with the description provided above.

Further acceptance criteria may be added to the second main set B as desired, such as Bn for example.

The functionality or processor 33 in FIG. 6 contains access to the necessary computer and communication hardware, including memory, software application programs etc., for processing the input data 31 and the acceptance criteria 32, for reading computer programs stored in computer readable form, as well as for the operation of the prize allocation and delivery notification system 100. The results of the prize allocation computations are provided as an output of the functionality or processor 33, as a result of one or more computation runs.

Prize-allocation computations may be conducted as real time calculations, at predetermined points in time, and even continuously, to constantly provide the most recent and up-to-date results. The operator is free to control the input data 31 and the acceptance criteria 32 applicable for a particular run of prize allocation computations. Other input data 31 and different acceptance criteria 32 may thus be freely selected.

As described above, the prize allocation and delivery notification system 100 may be decentralized over a plurality of remote locations in wired or wireless communication with each other, over one or more networks, including the Internet.

The prize allocation results, which are the output of processor 33, may be forwarded directly to a prize delivery unit 35 and/or to a notification unit 36 either directly or indirectly, for example, via a communication and delivery unit 34. The actual delivery of the prizes to the winning recipients may involve restrictions according to the criteria and conditions dictated by the operator and may be made directly via any known delivery means.

A notification regarding the allocation of prizes to winning subjects associated with electronic-game contests may also involve restrictions according to the criteria and conditions dictated by the operator, and may be made directly via any known communication means. For example, the operator may want to consider delivery of notification and prizes only to subjects who have previously applied and registered to receive such prizes and are recorded in a list of registrations. This list of registrations may be maintained in a database accessible to the processor 33. Subjects who have enrolled and are listed for registration related to electronic game subjects may further have to submit to the acceptance criteria 32.

FIG. 7 shows an example of the operation of the prize allocation and delivery notification system 100. The operation starts in step 40, and the input data of set A is read by processor 33 in step 41. Then the acceptance criteria of set B are read by processor 33 in step 42. In step 43, the acceptance criteria of set B are operated upon the input data set A, and a list of accepted input data is derived. In step 44, the total sum of accepted prizes is calculated and the list of accepted addresses for notification is set up. Thereafter, in step 45, a selected prize allocation distribution application computer program operates on the accepted calculated sum of prizes derived in step 44 and on the accepted ranking derived from the accepted input data in step 43. Step 46 provides the list of results of the allocated prizes and the winning recipients. For example, a simple scheme for the prize allocation distribution application computer program may be to first select the four top results for a subject associated with electronic games ranking from the list of results of the accepted ranking as per the accepted input data derived in step 43. Then, in step 45, prizes are allocated by distribution of the total sum of prizes as calculated in step 44 according to a percentage in reverse proportion to the order of ranking. For example, for four winning subjects, out of the total sum of prizes calculated in step 44, 40% may go to the first position, 30% to the second position, 20% to the third position, and 10% to the fourth position.

A list of the results of the allocated prizes is generated in step 46 and the prizes according to the allocations are then sent to winners in step 47, e.g., automatically by transfer to the winner's bank accounts. Prior to or substantially simultaneously with the sending of the allocated prizes to the selected winners in step 47, notifications of the allocated prizes are forwarded to the winners in step 48 according to the accepted addresses derived in step 44. The operation ends in step 49.

In one embodiment, a percentage of the accepted prizes may be transferred to the operator.

The foregoing provides significant benefits to electronic gaming. Specifically, it enables an easy implementation of a prize allocation and notification technique in which results of a ranking of subjects involved in playing electronic games are provided by a ranking calculation procedure, an equitable prize allocation distribution is determined, and notification to listed and registered applicants is provided. An operator exercises command and direction over the technique, in particular, parameters of the prize allocation and notification so that the operate can freely determine and regulate the manner in which prizes are allocated to the subjects and the manner in which the subjects are notified of their prizes.

Additional benefits of the invention include the implementation of a prize allocation and notification technique wherein notification is delivered on media channels selected by the operator, including for example, notification via the Internet. This may take the form of a banner directed to the recipient of the prize. Also, the derivation of equitable prize allocation distribution may be provided by dedicated computer application programs.

Moreover, the invention provides dedicated computer application programs operative to implement any of the techniques described above. Thus, several computer programs resident on computer-readable media may be used in the invention. One computer program 24 is resident in the server 10 to rank a plurality of subjects associated with electronic games, e.g., players, teams each including a plurality of players, games each involving a plurality of players or tournaments each involving a plurality of teams playing a plurality of games. Another computer program is resident in processor 14 to determine recipients of prizes based on their performance in electronic games, i.e., the ranking results 12, and the existence of sponsored prizes 18, and direct the notification and prize to the recipients via the prize and notification delivery unit 16. The same or a similar computer program may be resident in processor 33.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A method for determining recipients of prizes based on their performance in electronic games and notifying the recipients of their prizes, comprising:
ranking subjects involved in electronic games using a processor, the subjects being a plurality of players, a plurality of teams each including a plurality of players, a plurality of games each involving a plurality of players or a plurality of tournaments each involving a plurality of teams playing a plurality of games;
deriving a prize allocation distribution to the subjects based on the ranking; and
notifying the subjects that have been allocated prizes of their prizes.

2. The method of claim 1, further comprising:
enabling an operator to determine parameters for deriving the prize allocation distribution; and
enabling the operator to determine the manner in which the subjects are notified of their allocation of prizes.

3. The method of claim 1, further comprising:
enabling notification to be provided to the subjects via a plurality of different media channels; and
enabling an operator to select which of the different media channels to use to provide notification to the subjects.

4. The method of claim 1, wherein the step of notifying the subjects comprises notifying the subjects via the Internet.

5. The method of claim 1, further comprising enabling an operator to limit the prize allocation only to subjects previously registered to receive prizes.

6. The method of claim 1, wherein the step of ranking the subjects comprises:
receiving data about the subjects; and
applying a ranking calculation algorithm to the data in order to derive the ranking of the subjects.

7. The method of claim 6, wherein the ranking calculation algorithm includes a plurality of rules, further comprising enabling an operator to determine the rules for the ranking calculation algorithm to apply to the data in order to derive the ranking.

8. The method of claim 7, further comprising:
providing a first set of rules for ranking players;
providing a second set of rules for ranking teams;
providing a third set of rules for ranking games;
providing a fourth set of rules for ranking tournaments; and
enabling the operator to select from among any of the rules in the first, second, third and fourth sets to include in the ranking calculation algorithm.

9. The method of claim 1, further comprising displaying and distributing the ranking to interested parties.

10. A method for ranking a plurality of subjects associated with electronic games, the subjects being a plurality of players, a plurality of teams each including a plurality of players, a plurality of games each involving a plurality of players or a plurality of tournaments each involving a plurality of teams playing a plurality of games, the method comprising:
receiving data about each subject and information about games played;
applying predetermined rules to the data about the subjects and information about the games; and
deriving a ranking result for each of the subjects after application of the rules.

11. A system for determining recipients of prizes based on their performance in electronic games and notifying the recipients of their prizes, comprising:
ranking means for receiving data about subjects involved in electronic games and information about the games, the subjects being a plurality of players, a plurality of teams each including a plurality of players, a plurality of games each involving a plurality of players or a plurality of tournaments each involving a plurality of teams playing a plurality of games, said ranking means being arranged to derive ranking results from at least one of the data about the subjects and the information about the games; and
deriving means for deriving a prize allocation distribution to the subjects based on the ranking results; and
notifying means for notifying the subjects that have been allocated prizes of their prizes.

12. The system of claim 11, wherein said ranking means and said deriving means comprise a processor.

13. The system of claim 11, wherein said deriving means are arranged to enable an operator to determine parameters for deriving the prize allocation distribution and said notifying means are arranged to enable the operator to determine the manner in which the subjects are notified of their allocation of prizes.

14. The system of claim 11, wherein said notifying means are arranged to enable notification to be provided to the subjects via a plurality of different media channels and to enable an operator to select which of the different media channels to use to provide notification to the subjects.

15. The system of claim 11, wherein said deriving means are arranged to enable an operator to limit the prize allocation only to subjects previously registered to receive prizes.

16. The system of claim 11, wherein said data is contained in a database coupled to said ranking means.

17. The system of claim 11, wherein said ranking means are arranged to apply a ranking calculation algorithm to the data in order to derive the ranking of the subjects.

18. The system of claim 17, wherein the ranking calculation algorithm includes a plurality of rules, said ranking means being arranged to enable an operator to determine the rules for the ranking calculation algorithm to apply to the data in order to derive the ranking.

19. The system of claim 18, wherein said rules include a first set of rules for ranking players, a second set of rules for ranking teams, a third set of rules for ranking games and a fourth set of rules for ranking tournaments, said ranking means being arranged to enable the operator to select from among any of the rules in the first, second, third and fourth sets to include in the ranking calculation algorithm.

20. A system for ranking a plurality of subjects associated with electronic games, the subjects being a plurality of players, a plurality of teams each including a plurality of players, a plurality of games each involving a plurality of players or a plurality of tournaments each involving a plurality of teams playing a plurality of games, the system comprising:
means for applying predetermined rules to data about each subject and information about games played; and
means for deriving a ranking result for each of the subjects after application of the rules.

21. A computer program resident on computer-readable media and arranged to determine recipients of prizes based on their performance in electronic games and notify the recipients of their prizes, the computer program being arranged to:
rank subjects involved in electronic games, the subjects being a plurality of players, a plurality of teams each including a plurality of players, a plurality of games each involving a plurality of players or a plurality of tournaments each involving a plurality of teams playing a plurality of games;
derive a prize allocation distribution to the subjects based on the ranking; and
notify the subjects that have been allocated prizes of their prizes.

22. The computer program of claim 21, wherein the computer program is further arranged to:
enable an operator to determine parameters for deriving the prize allocation distribution; and
enable the operator to determine the manner in which the subjects are notified of their allocation of prizes.

23. The computer program of claim 21, wherein the computer program is further arranged to:
enable notification to be provided to the subjects via a plurality of different media channels; and
enable an operator to select which of the different media channels to use to provide notification to the subjects.

24. The computer program of claim 21, wherein the computer program is further arranged to enable an operator to limit the prize allocation only to subjects previously registered to receive prizes.

25. The computer program of claim 21, wherein the computer program is further arranged to rank the subjects by receiving data about the subjects and applying a ranking calculation algorithm to the data in order to derive the ranking of the subjects.

26. The computer program of claim 25, wherein the ranking calculation algorithm includes a plurality of rules, the computer program being further arranged to enable an operator to determine the rules for the ranking calculation algorithm to apply to the data in order to derive the ranking.

27. The computer program of claim 26, wherein the computer program is further arranged to enable an operator to determine the rules from among a first set of rules for ranking players, a second set of rules for ranking teams, a third set of rules for ranking games and a fourth set of rules for ranking tournaments.

28. A computer program resident on computer-readable media and arranged to rank a plurality of subjects associated with electronic games, the subjects being a plurality of players, a plurality of teams each including a plurality of players, a plurality of games each involving a plurality of players or a plurality of tournaments each involving a plurality of teams playing a plurality of games, the computer program being arranged to:
receive data about each subject and information about games played;
apply predetermined rules to the data about the subjects and information about the games; and
derive a ranking result for each of the subjects after application of the rules.
